(19) United States
(12) Patent Application Publication
(10) Pub. No.: US 2023/0219482 A1
(43) Pub. Date: Jul. 13, 2023

(54) LEVEL DECK CAPTIVATED BEAM SYSTEM AND METHOD

(71) Applicant: Steven E. Downing, Beaver Dam, WI (US)

(72) Inventor: Steven E. Downing, Beaver Dam, WI (US)

(21) Appl. No.: 18/096,370

(22) Filed: Jan. 12, 2023

Related U.S. Application Data
(60) Provisional application No. 63/298,910, filed on Jan. 12, 2022.

(51) Int. Cl. B60P 7/15

(52) U.S. Cl. CPC B60P 7/15

(57) ABSTRACT

A deck leveling system may include a track, a beam, a first foot assembly and/or a second foot assembly. The first and second foot assembles may be connected to the beam and may be configured to move along the track. The beam and the first and second foot assemblies may be configured to move relative to the track when the first and second foot assembles are in an unlocked state. The beam may be positioned perpendicular relative to the track when the first and second foot assembles are in a locked state. The beam may be in a position that is not perpendicular relative to the track when the first and second foot assembles are in the unlocked state.

### CROSS-REFERENCE TO RELATED APPLICATIONS

This application claims priority to U.S. Provisional Patent Application No. 63/298,910, filed on Jan. 12, 2022, the contents of which is hereby incorporated by reference in its entirety.

### TECHNICAL FIELD

The present disclosure generally relates to storage systems for use in cargo trailers, and in particular, to an improved system for adjusting and/or leveling the decking system in a cargo trailer.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Some decking systems may not provide sufficient functionality, are difficult to adjust and/or level, and/or required complicated assembly processes.

There is a desire for solutions/options that minimize or eliminate one or more challenges or shortcomings of decking systems. The foregoing discussion is intended only to illustrate examples of the present field and is not a disavowal of scope.

### OVERVIEW

In the embodiments, a system may include a track, a beam, a first foot assembly and/or a second foot assembly. The first and second foot assembles may be connected to the beam and may be configured to move along the track. The beam and the first and second foot assembles may be configured to move relative to the track when the first and second foot assembles are in an unlocked state. The beam may be positioned perpendicular relative to the track when the first and second foot assembles are in a locked state. The beam may be in a position that is not perpendicular relative to the track when the first and second foot assembles are in the unlocked state.

In another embodiment, the system may be operated by an operator releasing a first foot assembly without any tool such that the foot assembly moves vertically within a track to a desired vertical position, and then self-locks. Once the operator releases the first foot assembly, said assembly may automatically lock relative to the track. The operator may separately release a second foot assembly and it may traverse vertically within a second track to a desired position. When the operator releases the foot assembly it automatically engages the track and maintains its position.

The foregoing and other potential aspects, features, details, utilities, and/or advantages of examples/embodiments of the present disclosure will be apparent from reading the following description, and from reviewing the accompanying drawings.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is an end view generally illustrating an embodiment of a captivated beam deck leveling system according to teachings of the present disclosure.

FIG. 2 is a top view generally illustrating an embodiment of a system according to teachings of the present disclosure.

FIG. 3 is an exploded perspective view generally illustrating an embodiment of a foot assembly of a system according to teachings of the present disclosure.

FIG. 4 is a side view generally illustrating portions of embodiments of a foot assembly of a system according to teachings of the present disclosure.

FIG. 5 is a perspective view generally illustrating portions of embodiments of a foot assembly of a system according to teachings of the present disclosure.

FIG. 6 is a partial perspective view generally illustrating a foot assembly and a beam according to teachings of the present disclosure.

FIG. 7 is another partial perspective view generally illustrating a foot assembly and a beam according to teachings of the present disclosure.

FIG. 8 is yet another partial perspective view generally illustrating the underside of a foot assembly and a beam according to teachings of the present disclosure.

FIG. 9 is side view generally illustrating portions of a foot assembly and a beam according to teachings of the present disclosure.

FIG. 10 is a flowchart generally illustrating a method of operating the system show in FIG. 1.

### DETAILED DESCRIPTION

Reference will now be made in detail to embodiments of the present disclosure, examples of which are described herein and illustrated in the accompanying drawings. While the present disclosure will be described in conjunction with embodiments and/or examples, they do not limit the present disclosure to these embodiments and/or examples. On the contrary, the present disclosure covers alternatives, modifications, and equivalents.

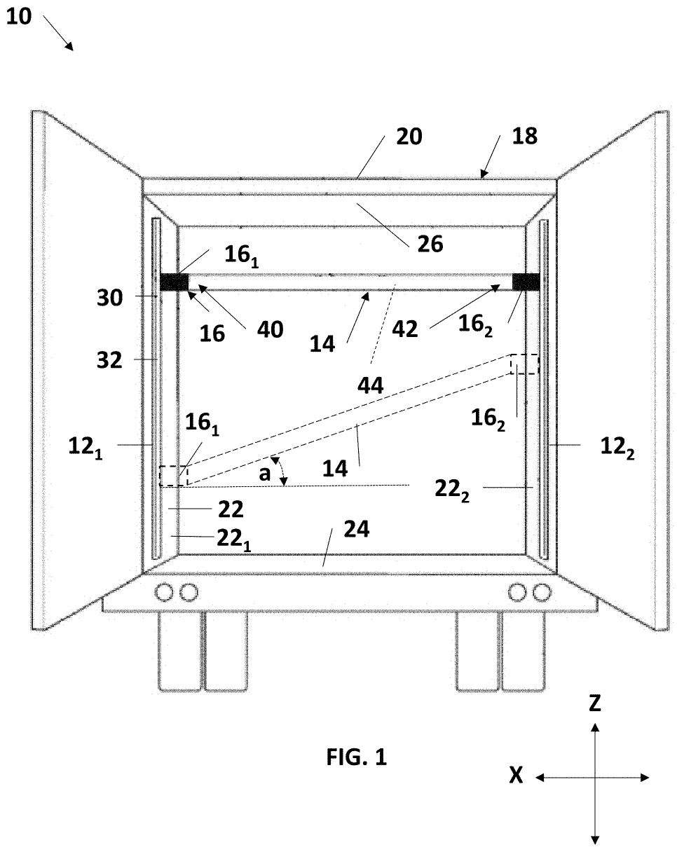

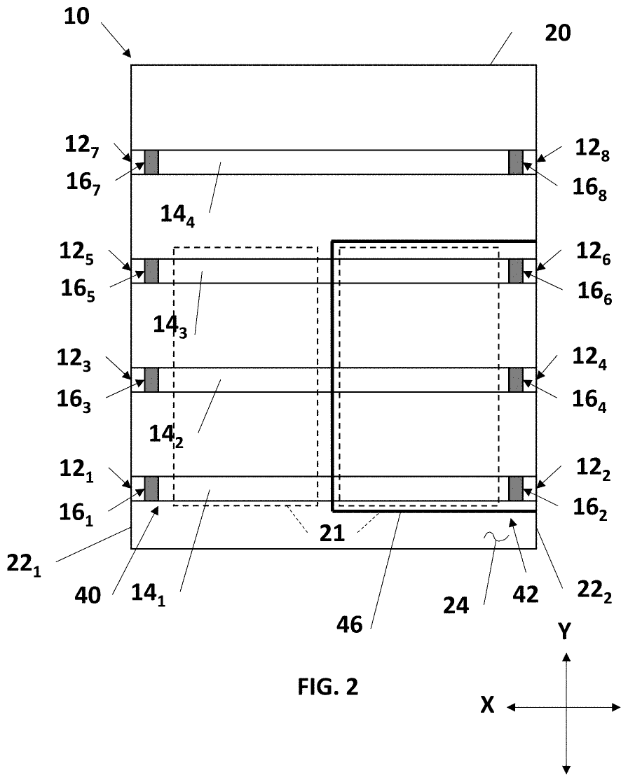

In embodiments, such as generally illustrated in FIGS. 1 and 2, a system 10 may include a plurality of tracks 12 (e.g., a first track 12₁, a second track 12₂, a third track 12₃, a fourth track 12₄, a fifth track 12₅, a sixth track 12₆, a seventh track 12₇, and/or an eighth track 12₈), a plurality of beams 14 (e.g., a first beam 14₁, a second beam 14₂, a third beam 14₃, and/or a fourth beam 14₄), a plurality of foot assemblies 16 (e.g., a first foot assembly 16₁, a second foot assembly 16₂, a third foot assembly 16₃, a fourth foot assembly 16₄, a fifth foot assembly 16₅, a sixth foot assembly 16₆, a seventh foot assembly 16₇, and/or an eighth foot assembly 16₈).

In some instances, the system 10 may be associated with a vehicle 18. For example, and without limitation, the system 10 may be disposed within a cargo trailer 20 of a vehicle 18. In some examples, the system 10 may not be associated with a vehicle 18 and/or may be disposed within a building (e.g., a warehouse, a storage facility, a manufacturing facility, among others), a ship, a rail car, a plane, or some other construct. The system 10 may be configured such that cargo 21 (e.g., pallets of goods) may be stacked upon, supported by, and/or secured to portions of the system 10. The system 10 may be configured to support heavy cargo 21.

With reference to the embodiments, a vehicle 18 may include one or more of a variety of configurations. For example, and without limitation, a vehicle 18 may include a land vehicle, a railroad car, a truck (e.g., a semi-truck, a commercial truck, a cargo truck, etc.), and/or a van, among others. A vehicle 18 may include and/or may be configured to haul the cargo trailer 20. In some example configurations, the cargo trailer 20 may include side walls 22, a floor 24, and/or a ceiling 26.

In some embodiments, a track 12 (e.g., tracks 12₁-12₈) may be secured (e.g., via fasteners, etc.) to side walls 22 of the cargo trailer 20. In an assembled configuration, a track 12 may extend in a direction (e.g., Z-direction) that is substantially perpendicular to the floor 24 and/or the ceiling 26 of the cargo trailer 20. A track 12 may be configured to receive portions of the foot assembly 16. In some instances, a track 12 may be elongated. A track 12 may include openings 30 for receiving a portion of a foot assembly 16 and/or a slot 32 that may extend along an entire length of the track 12. A track 12 may comprise a rigid material (e.g., metal, etc.). While the system 10 is shown including eight tracks, the system 10 may comprise more or less than eight tracks according to teachings of the present disclosure.

The system 10 may be customizable such that a user of the system 10 may arrange the tracks 12, the beams 14, and/or the foot assemblies 16 in various configurations. As generally illustrated in FIG. 2, the tracks 12 may be arranged within the cargo trailer 20 such that an equal number of tracks 12 are disposed on opposing side walls 22 (e.g., first side wall 221 and second side wall 222). The tracks 12 may be spaced on each side wall 22 such that tracks on one side wall (e.g., the first side wall 22₁) are aligned and/or correspond with tracks on the opposing side wall (e.g., the second side wall 22₂). For example, and without limitation, the first track 12₁, the third track 12₃, the fifth track 12₅, and/or the seventh track 12₇ may be disposed on the first side wall 22₁ and/or the second track 12₂, the fourth track 12₄, the sixth track 12₆, and/or the eighth track 12₈ may be disposed on the second side wall 22₂. The tracks 12 may be arranged such that the first track 12₁ is spaced apart from and/or opposes the second track 12₂, the third track 12₃ is spaced apart from and/or opposes the fourth track 12₄, the fifth track 12₅ is spaced apart from and/or opposes the sixth track 12₆, and/or the seventh track 12₇ is spaced apart from and/or opposes the eight track 12₈.

A beam 14 (e.g., beams 14₁₋₄) may include a first end 40 and a second end 42 spaced apart from the first end 40. A beam 14 may be elongated and/or hollow. For instance, a beam 14 may include an opening 44 that extends from the first end 40 to the second end 42. In some example configurations, a foot assembly 16 may be connected to and/or partially disposed within each of the first and second ends 40, 42. A beam 14 and/or a foot assembly 16 may be configured to move relative to a track 12. For example, and without limitation, the first foot assembly 16₁ may be connected to and/or partially disposed within a first end 40 of the first beam 14₁ and/or the second foot assembly 16₂ may be connected to and/or partially disposed within a second end 42 of the first beam 14₁. The third foot assembly 163 may be connected to and/or partially disposed within a first end 40 of the second beam 14₂ and/or the fourth foot assembly 16₄ may be connected to and/or partially disposed within a second end 42 of the second beam 14₂. The fifth foot assembly 16₅ may be connected to and/or partially disposed within a first end 40 of the third beam 14₃ and/or the sixth foot assembly 16₆ may be connected to and/or partially disposed within a second end 42 of the third beam 14₃. The seventh foot assembly 16₇ may be connected to and/or partially disposed within a first end 40 of the fourth beam 14₄ and/or the eighth foot assembly 16₈ may be connected to and/or partially disposed within a second end 42 of the fourth beam 14₄.

In the embodiments, each foot assembly 16 is connected to a corresponding track 12. For instance, the first foot assembly 16₁ may be connected to the first track 12₁, the second foot assembly 16₂ may be connected to the second track 12₂, the third foot assembly 16₃ may be connected to the third track 12₃, the fourth foot assembly 16₄ may be connected to the fourth track 12₄, the fifth foot assembly 16₅ may be connected to the fifth track 12₅, the sixth foot assembly 16₆ may be connected to the sixth track 12₆, the seventh foot assembly 16₇ may be connected to the seventh track 12₇, and/or the eighth foot assembly 16₈ may be connected to the eight track 12₈. Each foot assembly 16 may be selectively/releasably connected to (e.g., mechanically), move (e.g., slide) along and relative to, and/or be removed from the corresponding track 12. As generally illustrated in the figures, the system 10 is shown having a single beam coupled (e.g., indirectly) to opposing tracks, however more than one beam may be coupled to the same opposing tracks according to teachings of the present disclosure.

A beam 14 may engage at least a portion of the cargo 21. For instance, the cargo 21 may be stacked directly upon the beams 14. In some example configurations, at least two adjacent beams 14 may be utilized to support cargo 21. For example, and without limitation, the first beam 14₁, the second beam 14₂, the third beam 14₃ may support the same cargo 21. In some instances, the cargo 21 may be placed adjacent to additional cargo 21 such that the cargo 21 and the additional cargo 21 are supported by the same beams 14 (e.g., 14₁₋₃). In embodiments, a beam 14 may comprise a rigid material (e.g., a metal, etc.). In some example configurations, one or more external components 46 (e.g., straps, etc.) may be configured to secure the cargo 21 to portions of the system 10 (see, e.g., FIG. 2). For instance, one or more external components 46 may be used to prevent cargo 21 from moving relative to the beams 14. An external component 46 may wrap around at least a portion of the cargo 21 and connect to a side wall 22, a beam 14, and/or a track 12. The external components 46 may include various shapes, sizes, configurations, and/or materials. While the system 10 is shown including four beams, the system 10 may comprise more or less than four beams according to teachings of the present disclosure.

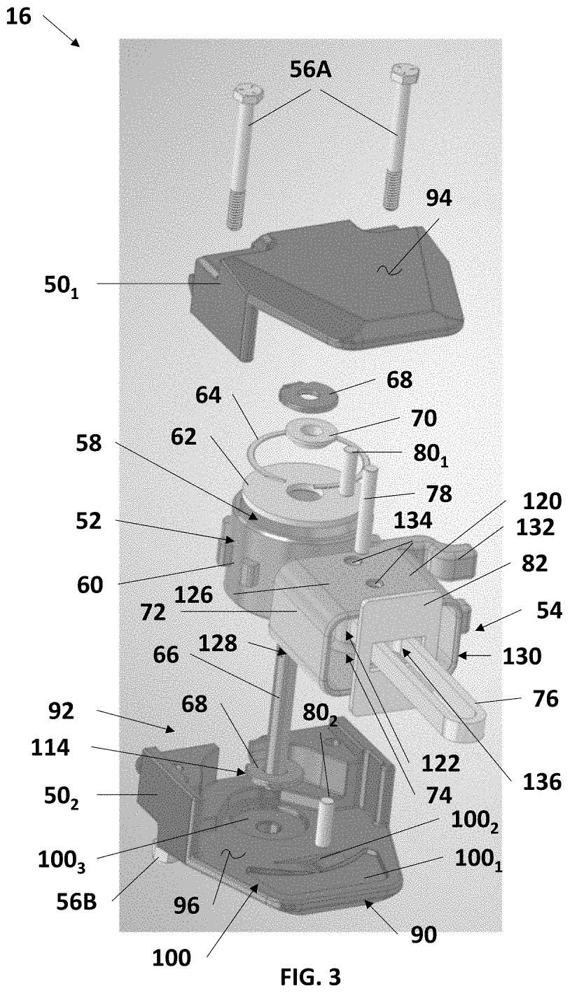

In one exemplary embodiment, such as generally illustrated in FIG. 3, a foot assembly 16 (e.g., foot assemblies 16₁₋₈) may include a first plate 50₁ (e.g., a first foot), a second plate 502 (e.g., a second foot), a power balancer assembly 52, and a release assembly 54. In an assembled configuration, the first plate 50₁ may be fixed to the second plate 502 such that a void is disposed between the first plate 50₁ and the second plate 50₂. The first plate 50₁ may be fixed to the second plate 50₂ via one or more fasteners 56 (e.g., a bolt 56A and nut 56B, among others). The power balancer assembly 52 and/or the release assembly 54 may be at least partially disposed within the void.

A foot assembly 16 may be configured to be slidably positioned along a track 12. A foot assembly 52 may be configured to slide along a track 12 in the Z-direction. A position of a foot assembly 16 along a track 12 may be adjustable such as to adjust a height of a beam 14 within a cargo trailer 20. The height of the beam 14 may include a distance between the beam 14 and the floor 24 of the cargo trailer 20. A foot assembly 16 may include a first state (e.g., a locked state) and/or a second state (e.g., an unlocked state). A foot assembly 16 may be fixed to and/or unable to move relative to a track 12 in the first state and/or may be configured to move along a track 12 in the second state. While the system 10 is shown including eight foot assemblies, the system 10 may comprise more or less than eight foot assemblies according to teachings of the present disclosure. Further, while FIG. 1 shows just one system 10 having one beam 14 and pair of foot assemblies 16 located within a track 12, it will be appreciated that a plurality of beams 14 with its respective foot assemblies 16 may be positioned on a given track 12. Such arrangement allows for multiple cargo loads 21 to be stacked vertically within the interior space of a trailer 20.

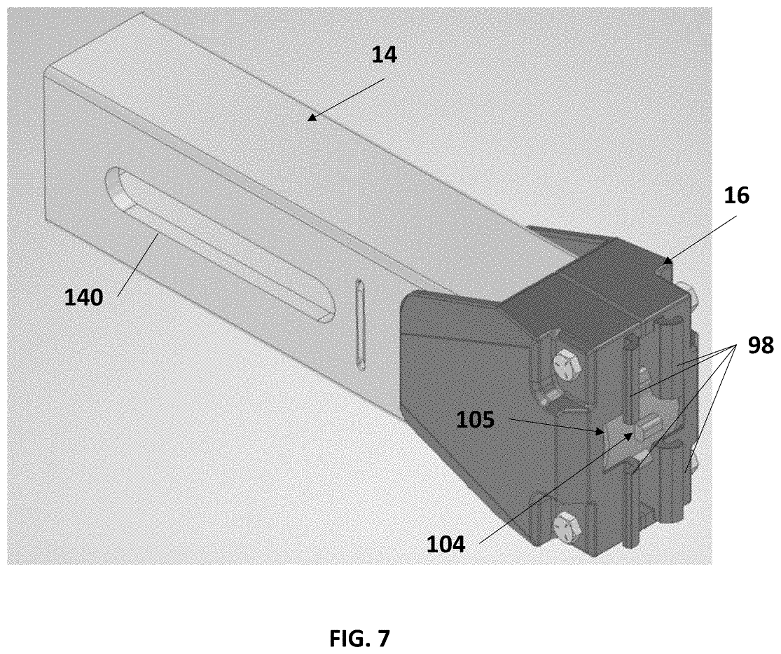

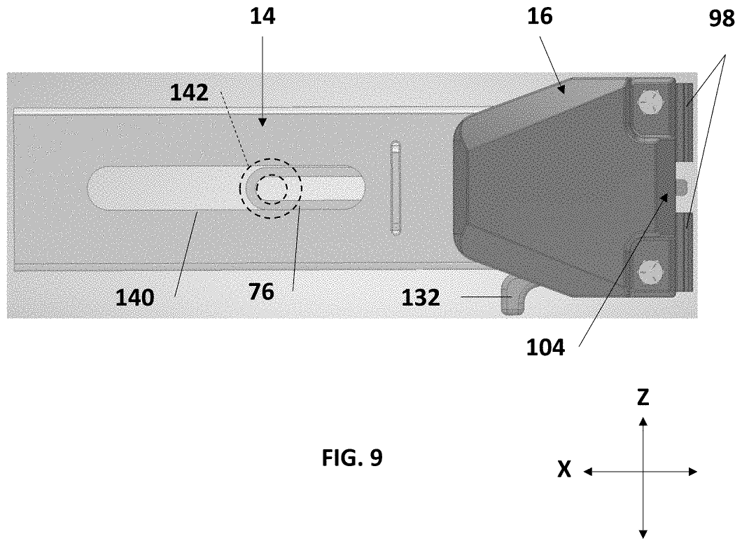

With continued reference to FIG. 3, a plate 50₁, 50₂ may include a first end 90, a second end 92 spaced apart from the first end 90, an outer surface 94, and/or an inner surface 96 disposed opposite the outer surface 94. The second end 92 of a plate 50₁, 50₂ may be configured to engage a track 12. For instance, a plate 50₁, 502 may include one or more elongated L-shaped portions 98 that are configured to engage a track 12 (see, e.g., FIGS. 7 and 9). The L-shaped portions 98 may extend from and/or along the second end 92 of a plate 50₁, 50₂.

As shown in FIG. 3, an inner surface 96 of a plate 50₁, 502 may include a plurality of indentations 100 such as a first indentation 100₁, a second indentation 100₂, and/or a third indentation 100₃. An indentation 100 may include a variety of shapes, sizes, and/or configurations. In some configurations, the first indentation 100₁ may be connected to and/or in communication with the second indentation 100₂.

As generally illustrated in FIGS. 3-5, a power balancer assembly 52 of a foot assembly 16 may include a spring 58, a spring case 60, one or more spring case covers 62, one or more spring case cover clips 64, a drive rod 66, one or more drive rod retention stops 68, and/or one or more drive rod bushings 70. The power balancer assembly 52 allows each foot assembly 16 to slidingly engage the track 12 in one instance and then to be locked to said track 12 in another instance. In some example configurations, the spring case 60 may include a cylindrical body 102 and/or a plurality of teeth 104. The teeth 104 may extend from and/or be disposed about the body 102. The teeth 104 may be evenly spaced about the body 102. The teeth 104 may be configured to engage a track 12. For instance, the teeth 104 may engage the openings 30 of a track 12. In an assembled configuration, the plates 50₁, 502 may define a void 105 such that the teeth 104 are accessible via the void 105 to engage a track 12 (see, e.g., FIG. 7).

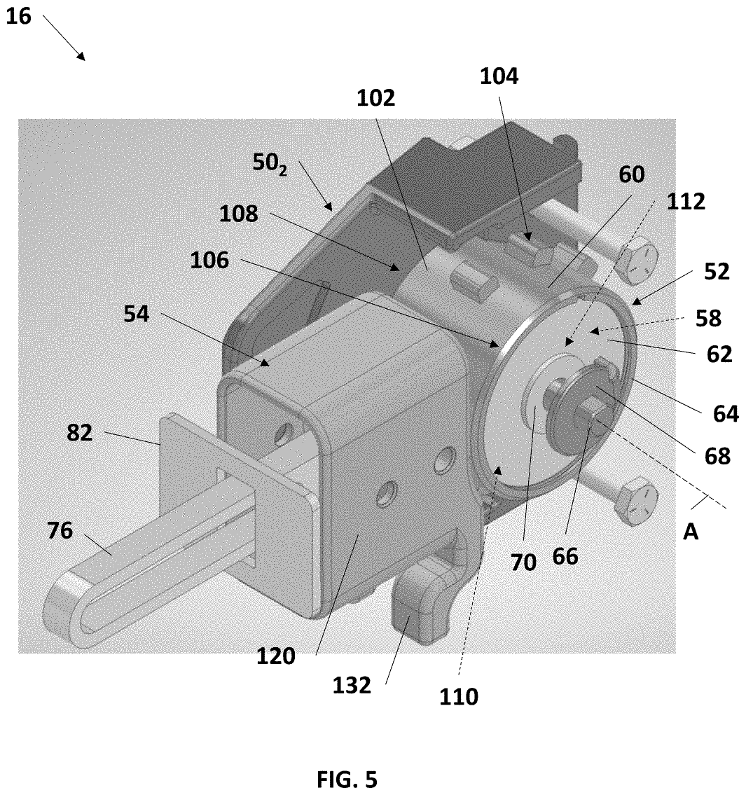

As seen in FIG. 5, a body 102 of a spring case 60 may include a first end 106, a second end 108 spaced apart from the first end 106, and/or an interior cavity 110 accessible via the first or second ends 106, 108. The spring 58 may be disposed within the cavity 110 and/or the drive rod 66 may be at least partially disposed within the cavity. A spring case cover 62 may be disposed at each end 106, 108 of the body 102 such as to enclose the spring 58 within the body 102. A spring case cover 62 may include a void 112 and the drive rod 66 and/or a drive rod bushing 70 may be at least partially disposed within the void 112. A spring case cover clip 64 may be configured to secure (e.g., fix) a spring case cover 62 to the body 102.

With continued reference to FIGS. 3-5, the drive rod 66 may include ends 114 that may be received by the third indentations or bosses 100₃ of the plates 50₁, 50₂. In some example configurations, the third indentations 100₃ may include a shape that is substantially similar to a shape of the ends 114 of the drive rod (e.g., cylindrical, circular, among others). The drive rod 66 may be disposed along and/or configured to rotate about an axis A (FIG. 5). The spring case 60 may be disposed about at least a portion of the drive rod 66. A rotation of the drive rod 66 may correspond to a rotation of the spring case 60.

With reference to FIG. 5, a drive rod retention stop 68 may be disposed about at least a portion of the drive rod 66 and/or proximate each end 114 of the drive rod 66. A drive rod retention stop 68 may be configured to engage a plate 50₁, 50₂ such as to stop rotation of the drive rod 66 and/or the spring case 60 if the foot assembly 16 reaches a predetermined position. A drive rod bushing 70 may be disposed about at least a portion of the drive rod 66 and/or adjacent each end 114 of the drive rod 66. A drive rod bushing 70 may be at least partially disposed between a spring case cover 62 and a drive rod retention stop 68.

A power balancer assembly 52 may be configured to rotate about the axis A. In some example configurations, a power balancer assembly 52 may be configured to bias a foot assembly 16 into the first state (e.g., a locked state) such as to secure (e.g., prevent from moving) a foot assembly 16 to a track 12.

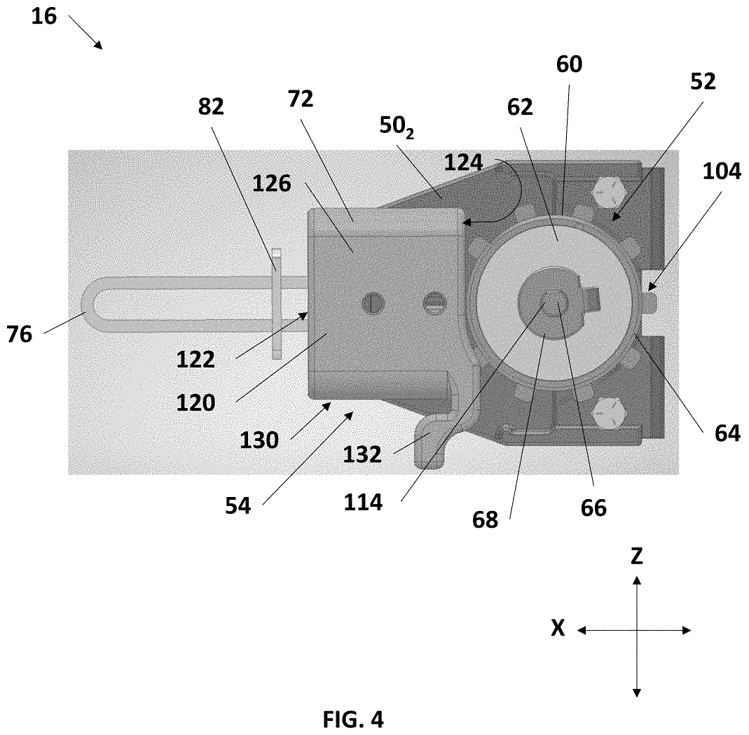

As shown in FIGS. 3-4, a release assembly 54 of a foot assembly 16 may include a locking lug 72, a locking lug spring 74, a release arm 76, a release arm attachment 78, one or more articulating unlock pins 80, and/or a spring retainer plate 82. A release assembly 54 may be configured to switch a foot assembly 16 from the first state (e.g., the locked state) to the second state (e.g., the unlocked state) such that the foot assembly 16 may move relative to a track 12 so that a height of a beam 14 may be easily adjusted by an operator without the need for any tools or other accessories, and with the use of only one operator. Thus, less manpower is needed in order to operate the system 10 which is beneficial where there is a manpower shortage.

A locking lug 72 may include a body 120 having a first end 122, a second end 124 spaced apart from the first end 122, a first side 126 extending between the first and second ends 122, 124, a second side 128 spaced apart from the first side 126, and/or a third side 130 extending between the first and second sides 126, 128. In some instances, the first and second ends 122, 124 may be open such as to allow access to an interior cavity of the body 120. One or more release tabs 132 may extend from the third side 130 of the body 120. The first and second sides 126, 128 may include through holes 134. The through holes 134 of the first side 126 may correspond and/or be aligned with the through holes 134 of the second side 128. The locking lug 72 may be configured to move relative to the power balancer assembly 52 (e.g., in the X-direction) (see, e.g., FIG. 4). For instance, the locking lug 72 may be disposed adjacent to and/or may engage the power balancer assembly 52 (e.g., the spring case 60) when a foot assembly 16 is in the first state (e.g., the locked state) defining a first position of the locking lug 72. The locking lug 72 may be moved away from and/or may be disengaged from the power balancer assembly 52, via a user of the system 10, when a foot assembly 16 is in the second state (e.g., the unlocked state) defining a second position of the locking lug 72.

The locking lug spring 74 may be disposed within the body 120 of the locking lug 72. The locking lug spring 74 may be configured to bias the locking lug 72 into the first position. The spring retainer plate 82 may be disposed adjacent to the first end 122 of the body 120 and/or may be configured to bias the locking lug spring 74 in the body 120. The spring retainer plate 82 may include a void 136. The release arm 76 may be at least partially disposed within the body 120 and/or the void 136 of the retainer plate 82. The release arm 76 may be elongated and/or may extend in a direction away from the body 120.

The release arm attachment 78 (e.g., a pin) may at least partially be disposed within the body 120 of the locking lug 72, a through hole 134 of the first side 126 of the body 120, and/or a through hole 134 of the second side 128 of the body 120. In some example configurations, the release arm attachment 78 may be connected to the release arm 76.

The release assembly 54 may include a first articulating unlock pin 80₁ and/or a second articulating unlock pin 80₂. The first pin 80₁ may be at least partially disposed within the body 120 and/or a through hole 134 of the first side 126 of the body 120. The second pin 80₂ may be at least partially disposed within the body 120 and/or a through hole 134 of the second side 128 of the body 120. A terminal end of a pin 80₁, 80₂ may extend from the body 120 such as to engage (e.g., be disposed within) the first and/or second indentations 100₁, 100₂ of a plate 50₁, 50₂. For instance, the first pin 80₁ may engage the first plate 50₁ and/or the second pin 80₂ may engage the second plate 50₂. A foot assembly 16 is configured such that a terminal end of a pin 80₁, 80₂ may only be disposed within the first and/or second indentations 100₁, 100₂ of a plate 50₁, 50₂.

With reference to FIG. 3, when the foot assembly 16 is in the first state (e.g., the locked state), the release assembly 54 is configured such that the terminal ends of the pins 80₁, 80₂ are disposed within the second indentation 100₂. While a foot assembly 16 is in the second state (e.g., the unlocked state) the release assembly 54 is configured such that the terminal ends of the pins 80₁, 80₂ are disposed within the first indentation 100₁. The indentations 100₁, 100₂ may be arranged such that the terminal ends of the pins 80₁, 80₂ move from the second indentation 100₂ to the first indentation 100₁ when a user manipulates the locking lug 72 (e.g., when a user applies a force to the release tabs 132) from the first position to the second position. The indentations 100₁, 100₂ may be arranged such that the terminal ends of the pins 80₁, 80₂ move from the first indentation 100₁ to the second indentation 100₂ when a user manipulates a beam 14 to a predetermined position. For instance, when a beam 14 is positioned approximately perpendicular (e.g., 90 degrees) relative to a track 12.

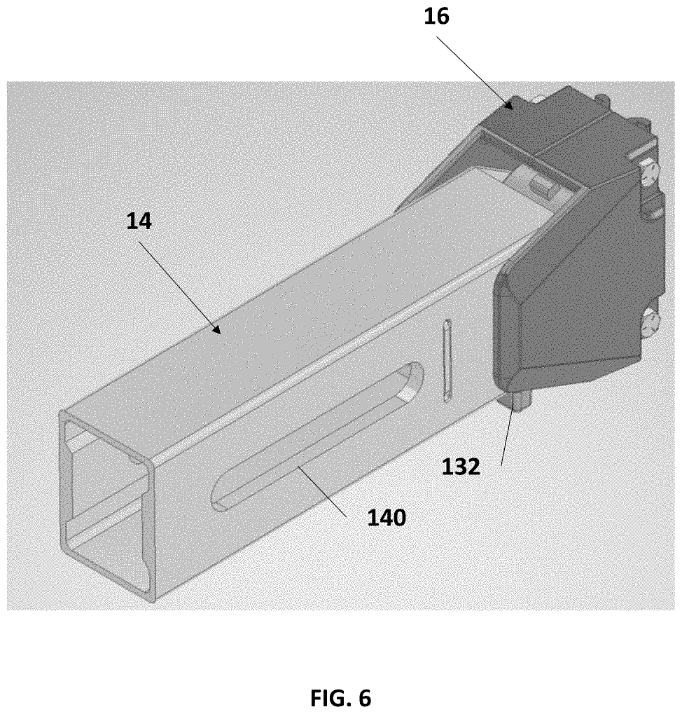

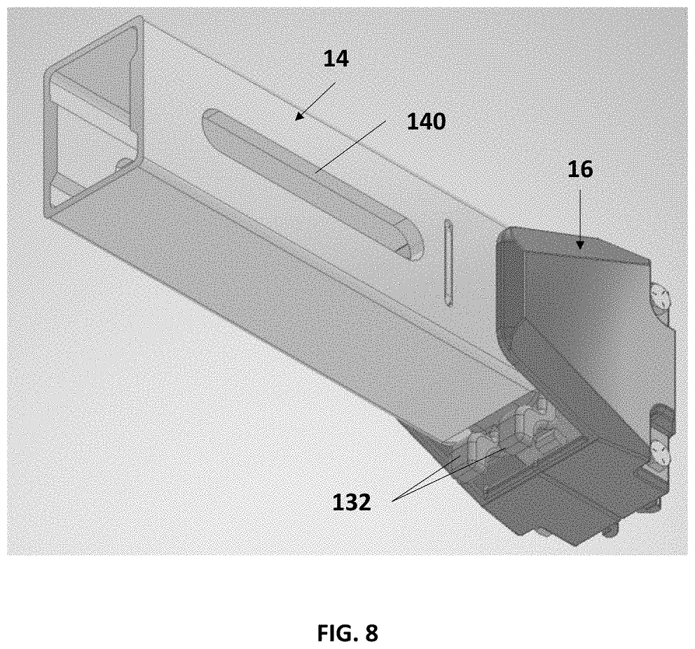

In the embodiments, such as generally illustrated in FIGS. 6-9, a foot assembly 16 is shown disposed proximate a terminal end of a beam 14. The foot assembly 16 is shown at least partially disposed within the beam 14. The beam 14 may be configured to move to an angle a (e.g., approximately 10-80 degrees and/or 100-170 degrees) (see, e.g., FIG. 1) relative to a track 12 when the foot assembly 16 is in the second state.

With reference to FIG. 9, a beam 14 may include voids 140 disposed on opposing side walls. The voids 140 may be aligned with a release arm 76 of the release assembly 54. A fastener 142 may be at least partiality disposed within the voids 140 such that a portion of the release arm 76 engages and/or wraps around a portion of the fastener 142. In some instances, if a beam 14 moves away from a foot assembly 16 (e.g., while an operator is adjusting a height of a beam) by a predetermined distance, the fastener 142 is configured to engage a terminal end of a void 140, such that the release arm 76 is configured to pulled a locking lug 72 of the release assembly 54 into an unlocked position and the foot assembly 16 is able to move relative to a track 12. A beam 14 may be coupled to a foot assembly 16 in part via a fastener 142.

A user of a system 10 may desire to adjust the height of one or more beams 14, for example and without limitation, to accommodate for various cargo 21 sizes. The system 10 is configured such that a single user may easily, safely, and efficiently adjust a height of a beam 14 while standing proximate one end 40, 42 of the beam 14. The system 10 is configured such that a user may manipulate a foot assembly 16 and/or beam 14 in numerous ways to adjust a height of a beam 14.

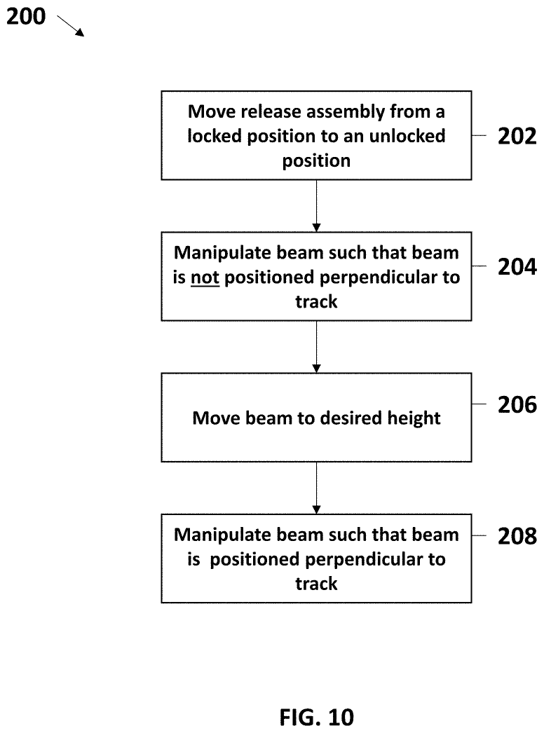

An example of one method 200 for adjusting a height of a beam 14 is generally illustrated in FIG. 10. The method 200 may include a user (e.g., an operator) moving a release assembly 54 of a first foot assembly 16 (e.g., 16₁) from a locked position to an unlocked position (block 202). For instance, the user may move a release table 132 of a locking lug 72 (e.g., of the first foot assembly 16 from the first position (e.g., a locked position) to a second position (e.g., an unlocked position). The release tab 132 may be easily manipulated by a user imparting motion on same by using his or her hand.

The method 200 may next include the user manipulating the beam 14 connected to the first foot assembly 16 such that the beam 14 is not positioned perpendicular to the track 12 that the first foot assembly 16 is connected to (block 204). For instance, the user may apply a downward or upward force (e.g., in the Z-direction) to the beam 14 (e.g., proximate one end 40, 42 of the beam 14) such that the beam 14 is moved away from being positioned perpendicular to the track 12. For example, and without limitation, the beam 14 may be moved such that the beam 14 is positioned approximately 10-80 degrees and/or 100-170 degrees relative to the track 12 (see, e.g., FIG. 1). When the beam 14 is moved to the position that is not perpendicular to the track 12, a second foot assembly 16 (e.g., 16₂) that is connected to the opposing end of the beam 14 may be configured to automatically switch from a locked state to an unlocked state.

For instance, as the first foot assembly 16 is unlocked via the user, the user will subsequently slide the first foot assembly 16 and/or the beam 14 relative to the track 12, as the second foot assembly 16 remains stationary. As the first foot assembly 16 moves along the track 12, a distance between the first and second foot assemblies 16 will increase. If the distance between the first and second foot assemblies 16₁ reaches a predetermined distance, the second foot assembly 162 is configured to automatically switch into an unlocked state. For example, a fastener 142 is configured to reach a terminal end of a void 140 of the beam 14 such that a release arm 76 of the second foot assembly 16 is configured to automatically pull the second foot assembly 16 into the unlocked state. For example and without limitation, the system 10 is configured such that a distance between the foot assemblies 16 when a beam 14 is at a position that is not perpendicular to the track 12 is greater than a distance between the foot assemblies 16 when the beam 14 is at a position that is perpendicular to the track.

The method 200 may next include the user moving the beam 14 to a desired height (block 206). For instance, the user may slide the beam 14 and the first and second foot assemblies relative to the track 12 until the desired height is reached.

The method 200 may next include the user manipulating the beam 14 such that the beam 14 is once again positioned perpendicular (e.g., approximately 90 degrees) relative to the track 12 (block 208). For instance, when the beam 14 is positioned perpendicular to the track 12, the first and second foot assemblies are configured to automatically switch from the unlocked state to the locked state. Thus, the method 200 contemplates a user being able to easily manipulate the system 10 relative to the track 12, and then the foot assembly 16 locking in place with the track 12, once a desired vertical height is achieved. Such is achieved without the use of external tools or without the need of multiple users.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example, and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

What is claimed is:

1. A system comprising:
a track;
a beam; and
a first and a second foot assembly connected to the beam and configured to move along the track;
wherein the beam and the first and second foot assembles are configured to move relative to the track when the first and second foot assembles are in an unlocked state;
the beam is positioned perpendicular relative to the track when the first and second foot assembles are in a locked state; and
the beam is in a position that is not perpendicular relative to the track when the first and second foot assembles are in the unlocked state.

2. The system of claim 1, wherein the first foot assembly is at least partially disposed within a first terminal end of the beam and the second foot assembly is at least partially disposed within a second terminal end of the beam.

3. The system of claim 1, wherein the beam is positioned approximately 10-80 or 100-170 degrees relative to the track when the first and second foot assembles are in the unlocked state.

4. The system of claim 3, wherein the beam is configured to support cargo; and
the system includes one or more external components configured to prevent the cargo from moving relative to the beam.

5. The system of claim 1, wherein the first and second foot assembles each include:
a first plate;
a second plate connected to the first plate such that a void is disposed between the first and second plates;
a power balancer assembly at least partially disposed within the void, the power balancer assembly is configured to bias the respective foot assembly into the locked state; and
a release assembly at least partially disposed within the void, the release assembly is configured to switch the respective foot assembly from the locked state to the unlocked state.

6. A method of operating a system, the method comprising:
moving a release assembly of one of a first foot assembly or a second foot assembly to an unlocked position;
manipulating a beam such that the beam is in a position that is not perpendicular to a track;
moving the beam to a desired height; and
manipulating the beam such that the beam is positioned perpendicular to the track.

7. The method of claim 6, wherein manipulating the beam such that the beam is in a position that is not positioned perpendicular to the track includes a user applying a downward or upward force to the beam proximate a terminal end of the beam.

8. The method of claim 6, wherein the other one of the first foot assembly or the second foot assembly is configured to automatically switch into the unlocked state when the beam is in the position that is not perpendicular to the track and the first foot assembly is spaced apart from the second foot assembly by a predetermined position.

9. The method of claim 6, wherein moving the beam to a desired height includes sliding the first and second foot assemblies and the beam relative to the track.

10. The method of claim 6, wherein the first and second foot assemblies are configured to automatically switch from the unlocked state to the locked state when the beam is positioned perpendicular to the track.

11. A foot assembly, comprising:
a first plate;
a second plate connected to the first plate such that a void is disposed between the first and second plates;
a power balancer assembly at least partially disposed within the void; and
a release assembly at least partially disposed within the void, the release assembly is configured to switch the respective foot assembly from a locked state to an unlocked state.

12. The foot assembly of claim 11, wherein the foot assembly is configured to selectively move along a track.
